(19) United States
(12) Patent Application Publication
(10) Pub. No.: US 2008/0142452 A1
(43) Pub. Date: Jun. 19, 2008

(54) APPARATUS AND METHOD FOR PREVENTING BIOLOGICAL REGROWTH IN WATER

(75) Inventors: RAYMOND P. DENKEWICZ, EAST GREENWICH, RI (US); ROLF ENGELHARD, PRESCOTT, AZ (US); RONALD MARTIN, CHELMSFORD, MA (US)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(73) Assignee: VORTEX CORPORATION, PRESCOTT, AZ (US)

(21) Appl. No.: 11/831,187

(22) Filed: Jul. 31, 2007

Related U.S. Application Data
(60) Provisional application No. 60/821,080, filed on Aug. 1, 2006.

(51) Int. Cl. C02F 9/12; B01D 61/58

(52) U.S. Cl. 210/748; 210/255

(57) ABSTRACT

A flow of oxygen containing gas is irradiated with UV light to convert oxygen molecules to ozone molecules and produce an ozonated gas. Water to be treated is augmented with silver prior to entraining the ozonated gas in the water. The ozone enriched water containing silver is irradiated with UV light to produce hydroxyl radicals. Whereby, microorganisms are killed by the UV radiation, organic matter is oxidized by the ozone and the combination of silver and hydroxyl radicals prevent downstream growth of bio-film contamination.

### CROSS REFERENCE TO RELATED APPLICATIONS

The present application discloses subject matter common to and claims priority of a provisional patent application entitled “Apparatus and Process for Preventing Biological Regrowth” filed Aug. 1, 2006 and assigned Ser. No. 60/821,080 describing an invention made by the present inventors and assigned to the present assignee.

### GOVERNMENT LICENSE RIGHTS

The U.S. Government has a paid-up license in this invention and the right in limited circumstances to require the patent owner to license others on reasonable terms as provided by the terms of Contract No. NBCHC060008 awarded by the Department of Homeland Security.

### BACKGROUND OF THE INVENTION

1. Field of the Invention

The present invention relates to the treatment of water for killing microorganisms and preventing bacterial regrowth.

2. Description of Related Prior Art

Most water treatment processes, particularly municipal drinking water treatment, seek to accomplish two major microbiological objectives. The first objective is to significantly reduce, inactivate or kill microorganisms such as bacteria, viruses and protozoa from the water. The second objective is to prevent regrowth of the microorganisms downstream of the treatment system. In the specific instance of drinking water treatment (see EPA Guidance Manual, “Alternative Disinfectants and Oxidants”, U.S. EPA 815-R-99-014, April 1999) the first objective is typically accomplished with so called primary disinfectants such as chlorine, chlorine dioxide, ultraviolet (UV) light or ozone. Bacterial regrowth is typically prevented with so called secondary disinfectants (secondary residuals) such as chloramines, chlorine or chlorine dioxide. Technologies such as UV light and ozone, which do not remain in the water for an extended period of time, are not useful as secondary residuals. Metal ions or salts of various metals, such as silver, copper and zinc can also be used as secondary residuals. The use of silver and/or copper has found utility in controlling bacterial regrowth in drinking water, cooling tower water, and medical and dental applications (Lin et al, 1998, Klueh et al, 2000, Armon et al, 200, Sabria and Yu, 2002, Abe et al, 2004, Samuel and Guggenbichler, 2004, Stout and Yu, 2003).

UV irradiation has been extensively used to inactivate microorganisms. The use of UV light is gaining popularity in drinking water treatment as it does not form Disinfection-by-Products (DBPs) such as trihalomethanes (THMs) and haloacetics acids (HAAs) and there is no need to store or handle chemicals. UV light disinfection is very effective against bacteria, protozoan parasites (Giardia, Cryptosporidium), and most enteric viruses. However, very large doses are required to inactivate the double-stranded DNA adenoviruses.

Microbial inactivation is proportional to the UV dose, which is expressed in microwatts-seconds per square centimeter (μwatt-s/cm²) or in units of millijoules per square centimeter (mJ/cm²). UV radiation at a wavelength of approximately 260 nm damages microbial DNA or RNA. At this wavelength it causes thymine dimerization which blocks nucleic acid replication and effectively inactivates microorganisms. The initial site of UV damage in viruses is the genome, followed by structural damage to the virus protein coat. Photo reactivation (i.e. repair of the UV damage) occurs in some UV light-damaged microorganisms. In these instances, repair is accomplished by a photo activating enzyme, which binds and then splits the thymine dimers. To prevent photo reactivation, sufficient doses must be applied.

A minimum dose of 16,000 watt-s/cm² (16 mJ/cm²) has been recommended for drinking water as this results in 99.9% inactivation of coliforms. Higher doses are required for inactivation of enteric viruses and protozoan cysts. Table 1 lists the UV dose required to kill 90% of a number of different enteric viruses.

TABLE 1
UV Dose to Kill 90% Enteric Microorganisms
(from Maier et al, 2000)

| | UV Dose | | UV Dose |
|---|---|---|---|
| Organism | (watt-s/cm²) | Organism | (watt-s/cm²) |
| E. Coli | 1,300-3,000 | Y. Enterocolitica | 1,100 |
| K. Terrigena | 3,900 | L. Pneumophila | 920-2,500 |
| S. Typhi | 2,100-2,500 | S. Dysenteriae | 890-2,200 |
| V. Cholera | 650-3,400 | Adenovirus | 23,600-30,000 |
| Coxackievirus | 11,900-15,600 | Echovirus | 10,800-12,100 |
| Poliovirus | 5,000-12,000 | Hepatitis A | 3,700-7,300 |
| Rotavirus SA11 | 8,000-9,900 | Coliphage MS-2 | 18,600 |

Recently, Butkus et al (2004) have demonstrated an unexpected synergy for MS-2 virus inactivation when silver ions were utilized in combination with UV light. The combined effect, as shown by the bar graph in FIG. 1, achieves significantly greater bacterial reduction than the individual components alone. Column (1) depicts the use of silver alone. Column (2) depicts the use of UV alone. Column (3) depicts the MATHEMATICAL PREDICTED PERFORMANCE when the effect of column (1) is added to column (2). Column 4 illustrates the ACTUAL combined silver/UV performance. Column (5) is similar to column (4) except the test time was extended (from Butkus, et al, 2004).

Silver, in its own right, is an effective, albeit slowly acting, broad spectrum antimicrobial. Metallic silver and silver ions have been used for centuries to control pathogen exposure from water. More contemporaneously, silver has been used successfully in hospital drinking water systems for over a decade to control Legionella (Stout and Yu, 2003) and is currently used in millions of home water treatment products to control bacterial growth on carbon filters. Both the EPA and the World Health Organization recognize silver as safe for drinking water.

Silver will bind with various species in water (e.g. chloride, phosphate, sulfides) and its overall contribution to disinfection may be hindered. Recently, Butkus et al (2005) discovered that the synergistic action that had been observed between UV and silver was reduced in the presence of chloride concentrations greater than 30 mg/L and high phosphate concentrations (above 5 nM).

Ozone is a powerful oxidizing agent that does not produce THMs or other chlorinated by-products. However, aldehydes and bromates may be produced by ozonation and may have adverse health effects. Because ozone does not leave a lasting residual in the water, ozonation needs to be followed by a secondary disinfectant such as chlorine, chloramine or silver ions. The effectiveness of ozone is not influenced by pH or ammonia content of the water being treated.

Ozone is a much more powerful oxidant than chlorine and its Concentration*Time (CT) values for enteric bacteria and enteric viruses are generally an order of magnitude or more lower than those of chlorine. Ozone appears to inactivate bacteria by mechanisms similar to that of chlorine: nucleic acid denaturization, impairment of enzyme function and/or protein integrity by oxidation of sulfhydral groups, and disruption of membrane permeability (Steward and Olson, 1996).

Ozone can be produced from air or oxygen using corona discharge methods or by the exposure of air or oxygen to UV light. UV light of a 185 nm wavelength readily converts oxygen to ozone.

Ozone consumption in natural waters has been observed to occur in two phases (Buffle, 2005). In the first phase, which spans only the 20 seconds or so, ozone depletion is very rapid. This phase is referred to as “Instantaneous Ozone Demand” (IOD). Since very little disinfection is achieved in this phase, it is presumed that the ozone demand arises from organics, meaning that the ozone is consumed for oxidation and not disinfection. During the second phase, ozone accomplishes disinfection and to a lesser extent oxidation. The first and second phases are illustrated in FIG. 2.

The combination of UV light and ozone creates a potent oxidizer called hydroxyl radicals that destroy any organic matter (including pesticides, microorganisms) in its path. The US EPA (1980) found that combined UV/ozone treatment was 4-50 times faster at oxidation than UV or ozone alone, depending on the specific water contaminants and water conditions.

The UV/ozone reaction can be described as,

UV+O₃→OH*

where OH* represents a hydroxyl radical.

The oxidation potential of hydroxyl radicals is 2.07 volts and is second only to fluorine in its oxidizing power. For this reason, processes that generate and use hydroxyl radicals have been termed Advanced Oxidation Processes. Hydroxyl radicals are generally utilized for oxidation as opposed to disinfection. Their non-selective oxidizing ability, compared to the selective oxidizing behavior of ozone, may cause even greater microorganism inactivation. For example, Magbanua et al (2006) recently demonstrated a synergistic effect between UV and ozone in the inactivation of E. coli. They found that when ozone is used with UV, they could lower the UV dose by up to a factor of 10 to achieve the same result as using UV alone. Moreover, they found that when using UV with ozone, they could lower the ozone dose by a factor of 4 to achieve the same result as using ozone alone.

DBPs (Disinfection-by-Products) arise when disinfectants such as chlorine interact with natural organic matter. The resulting by-products include Trihalomethanes (THMs) and Haloacetic acids (HAAs), chemical families that have been associated with adverse health effects. It is suspected that long-term exposure to THMs may statistically increase the rates of some cancers. Because of this finding, the EPA began, in 1979, to regulate the maximum contaminant level (MCL) for THMs and HAAs. These regulations are becoming more stringent with time. The Stage 1 D/DBP standard is 0.08 mg/L THMs and 0.06 mg/L HAAs. The proposed Stage 2 D/DBP standard will require no greater than 0.04 mg/L of THMs and no greater than 0.02 mg/L of HAAs.

The use of UV and ozone are well known to improve the reduction of DBP formation. This has been shown not only for THMs but also for HAAs (Chin and Berube, 2005).

Once drinking water is treated, it must travel through many miles of plumbing (i.e. pipe) or be held in storage tanks before it reaches the end user. The presence of dissolved organic compounds such as humates can cause bacterial colonization of water distribution systems (Bitton, 1994). Bio-films of microorganisms in the distribution system are of concern because of the potential for the protection of pathogens from the action of the secondary disinfectant.

Bio-films may consist of a monolayer of cells in a microcolony or can be as thick as 10-40 mm as algal mats at the bottom of a water reservoir (Geldreich, 1996). Bio-films are held together by extracellular polymeric matrix called a glycocalyx that protects microorganisms from the effects of the residual disinfectant in the water system. The occurrence of even low levels of dissolved organics, such as humates, allow for the growth of bio-film. Secondary residuals that are also strong oxidizers (e.g. chlorine, chloramines and chlorine dioxide) will combine (i.e. oxidize) with the humates. In fact, an abundance of humates will deplete the entire secondary residual leaving the system vulnerable to bio-film growth. Because silver does not act through an oxidative mechanism, it can be expected not to suffer this disadvantage (Armon et al 2000).

Only Engelhard and Kasten (U.S. Pat. No. 6,267,895) have brought together the combination of silver, ozone and UV for water treatment and control of bio-film. In their work, specific to the control of bio-film and organism development in dental lines, they placed the silver after the UV and ozone and did not recognize or anticipate the benefits of introducing silver upstream of the UV and ozone.

### SUMMARY OF THE INVENTION

In the present invention, silver, ozone and UV are combined to create a chlorine free water treatment system to inactivate microorganisms, lower DBP formation and prevent biological regrowth in the water distribution system. Silver is introduced in advance of the UV radiation and ozone to take advantage of a previously unknown synergistic effect between silver and ozone. By having the injected ozone in the water stream immediately converted to hydroxyl radicals (through photolysis with UV254), there appears to be no loss in disinfection efficacy over ozone. In other words, hydroxyl radicals perform as well as ozone for disinfection. This result is surprising given that ozone is generally regarded by the water treatment industry as a disinfectant (and oxidant) whereas hydroxyl radicals are generally considered for oxidation purposes only. Collectively, when the ozone/silver is followed by application of UV, an unexpected level of inactivation of microorganisms is achieved. The mechanism of action to bring about this result is not entirely understood.

It is therefore a primary object of the present invention to provide for introduction of silver prior to entrainment of ozone in water subsequently irradiated with UV light in a water treatment apparatus.

Another object of the present invention is to provide primary disinfectants and secondary residuals to purify and maintain pure drinking water.

Yet another object of the present invention is to provide apparatus for preventing growth of bio-film in conduits and water tanks that ultimately provide water to an end user.

Still another object of the present invention is to provide apparatus for disinfecting and preventing growth of bio-film in water used in conjunction with cooling towers, agricultural water dispensing apparatus, water coolers, food and beverage processing equipment and municipal drinking water systems.

A further object of the present invention is to provide apparatus which does not rely upon chlorine for short term and long term disinfection of water thereby preventing DBP formation.

A still further object of the present invention is to provide a method for introducing silver in water to be purified prior to entrainment of ozone and UV irradiation.

A yet further object of the present invention is to provide a method for inactivating microorganisms and preventing biological regrowth in water systems.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is a prior art bar graph illustrating inactivation of MS-2 by silver, UV and an combination of silver and UV;

FIG. 2 is a prior art graph illustrating ozone concentration versus time and showing the first and second phases of depletion;

FIG. 3 is a representative cross sectional view of apparatus for purifying water and for preventing bio-film formation; and

FIG. 4 is a representative cross sectional view of a variant apparatus for purifying water and for preventing bio-film formation.

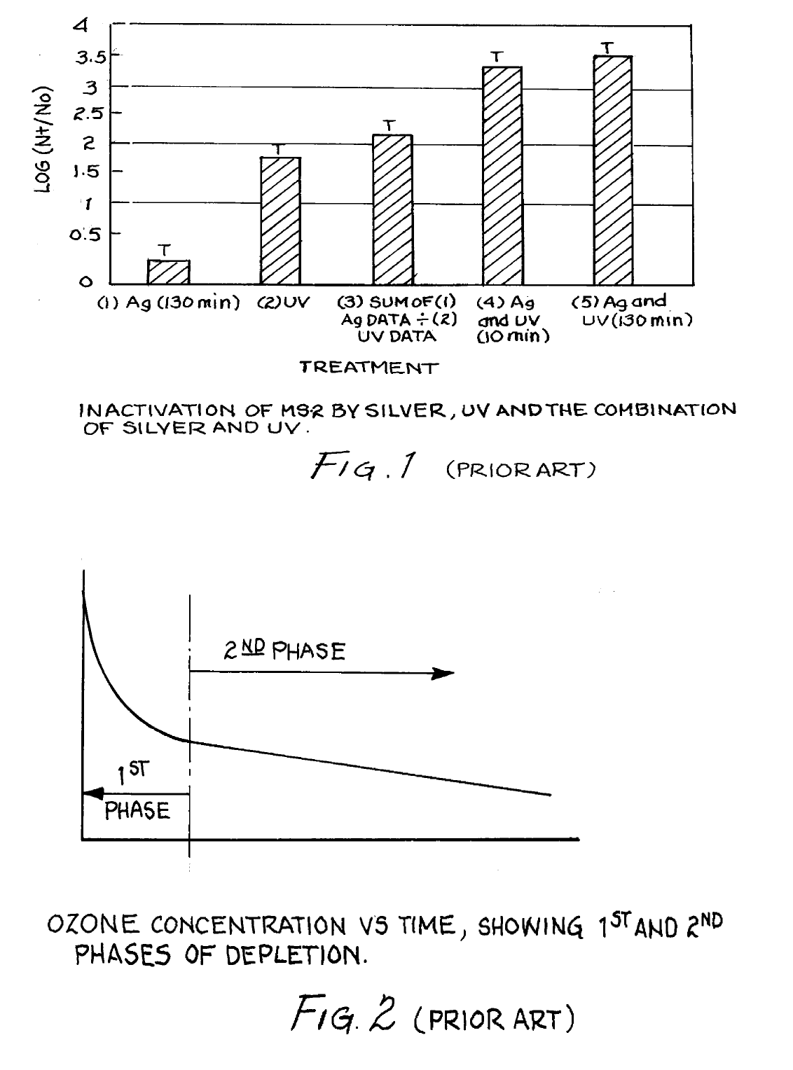

### DESCRIPTION OF THE PREFERRED EMBODIMENT

It can be theorized that the high level of oxidizing power hydroxyl radicals present throughout the water purification apparatus of the present invention maintains the silver in a chemical state conducive for interaction of the silver with UV. It is noted that Butkus et al (2005) observed a lowering of the effect of silver with UV when chloride or phosphate was present. In the present invention, an unexpected result was observed to the effect that no such lowering of the efficacy occurred despite the presence of chloride and/or phosphate. Another theory for the observed efficacy of the present invention could be that ozone, when used alone, is rapidly depleted from oxidation demands in the water (note the instantaneous ozone demand above) whereas when hydroxyl radicals are used, their non selective behavior is directed to all organisms in the water, including those that are microbial in nature. Somewhat similarly, Elovitz et al (2000) demonstrated that under varying water quality conditions (e.g. pH, temperature, dissolved organic matter) hydroxyl radical exposure (i.e. concentration integrated over time) remained almost unchanged whereas the ozone exposure varied by several orders of magnitude. Hence, water quality parameters have a major effect on ozonation for oxidation and disinfection whereas hydroxyl radical effectiveness is effectively invariant. A yet further theory relates to the unique behavior of UV light and ozone for advanced oxidation. While the combined catalytic oxidants can be used to generate hydroxyl radicals (e.g. UV-H₂O₂, O₃—H₂O₂ and UV-TiO₂, UV-O₃), Gottschalk et al (2000) showed that the O₃ UV process provides a maximum yield of hydroxyl radicals.

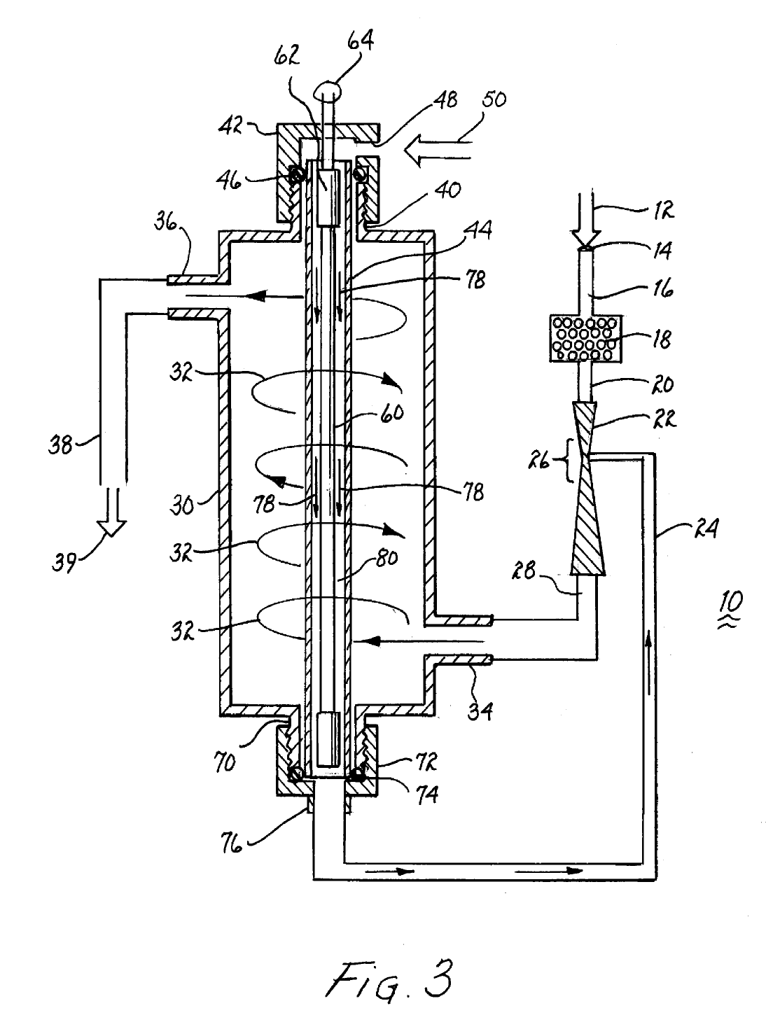

Referring to FIG. 3, there is representatively shown a water purifier 10. Water to be purified, represented by arrow 12, enters through inlet 14 into conduit 16. The conduit conveys the water to and through a silver media cartridge 18 of one of many types presently available from various commercial sources. The silver media cartridge releases silver (silver ions) into the water to achieve a desired concentration of silver. A further conduit 20 conveys the water containing silver to and through a venturi 22. A pipe 24 is connected to low pressure section 26 of the venturi. As is well known, the low pressure section of a venturi will draw a fluid into the venturi for entrainment with the further fluid flowing through the venturi. Thus, the fluid, in this case ozone, in pipe 24 will be drawn into the water (further fluid) flowing through the venturi and become entrained therein. The water with entrained ozone and silver flows from venturi 22 into a yet further conduit 28, which is in fluid communication with tank 30. As depicted by arrows 32, the water flowing into tank 30 through inlet 34, will tend to swirl within the tank.

Tank 30 includes a hollow threaded boss 40 extending from the top of the tank for threaded engagement by a cap 42. A sleeve 44 of UV transmissive material, such as quartz, extends into boss 40 and is retained in place by an O-ring 46 compressed by cap 42 against boss 40 to provide a sealing function and a retention function for the sleeve. It is to be understood that other apparatus may be employed to secure the sleeve in place. An inlet 48 in cap 24 provides for an inflow of air or other oxygen containing gas, as represented by arrow 50. It is to be understood that piping or other gas conveying structures may be employed to channel the gas into cap 42 under ambient or greater than ambient pressure. An ultraviolet (UV) lamp 60 capable of producing germicidal UV254 and ozone generating UV 185 is disposed within sleeve 44. Base 62 of the UV lamp may be secured within sleeve 44, as depicted, or by retention elements attendant cap 42. Electrical conductors 64 interconnect the UV lamp with a source of electrical power.

A further hollow threaded boss 70 extends from the bottom of tank 30 to receive therein sleeve 44. Moreover, UV lamp 60 may extend within the sleeve into proximity of boss 70, as illustrated. A further cap 72 is in threaded engagement with boss 70. An O-ring 74, or the like, may be disposed intermediate sleeve 44, boss 70 and cap 72 to provide a retaining function for the lower end of the sleeve and to provide a seal between the sleeve, the UV lamp and the interior surface of the boss. Other means for retaining the lower end of the sleeve and to provide a sealing function may be employed. Cap 72 includes an outlet 76. Outlet 76 is connected to and in fluid communication with pipe 24 terminating at venturi 22, as described above.

As depicted by arrows 78 in annular space 80 between UV lamp 60 and the interior surface of sleeve 44, air (or oxygen containing gas) will flow through the annular space and become irradiated by radiation from the UV lamp. The wavelength of the ultraviolet light is preferably 185 nm (UV185) as irradiation of the oxygen molecules present in the air/gas flowing through annular space 80 are particularly susceptible to conversion to ozone molecules at this wavelength. Thus, ozone molecules are created and will flow with the air/gas into venturi 22 to ultimately become entrained in the water flowing into tank 30.

Water containing entrained ozone and silver enters tank 30 through inlet 34. The flow of the water is generally in a swirling motion about sleeve 44, as represented by arrows 32. Upon energization of UV lamp 60, the water within tank 30 will be irradiated with ultraviolet light. Such irradiation will have a virucidal and bactericidal effect upon microorganisms that may be present. The UV radiation will also convert entrained oxygen molecules in the water to ozone molecules. The presence of ozone in the water will result in oxidation of organic matter. Additionally, the combination of ozone and UV radiation will produce hydroxyl radicals in the water. The ozonated, irradiated water containing silver will flow from tank 30 through outlet 36 into a conduit 38 to the ultimate user, as represented by arrow 39.

In summary, the water discharged from tank 30 into conduit 38 and to ultimate user 39 will have entrained therein a certain amount of ozone, silver and hydroxyl radicals. As discussed above, not only does this combination purify the water within tank 30 but the formation and regrowth of bio-film and other contaminants is severely restrained or prevented.

If the radiation from UV lamp 60 is also at a wavelength of 254 nm (UV 254), the UV radiation will have a strong germicidal and virucidal effect upon any microorganisms present in the air flowing through annular space 80 or within the water swirling about sleeve 44. Additionally, irradiation of the ozone with UV 254 will convert the ozone to hydroxyl radicals through a photolysis process.

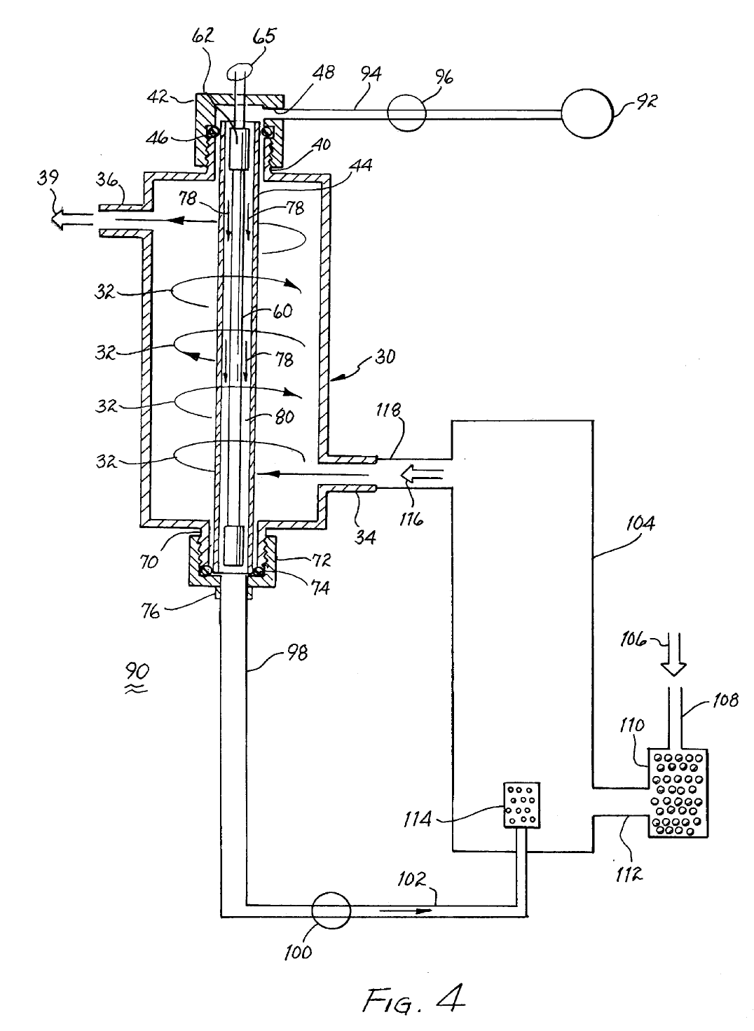

A variant water purifier 90 is representatively illustrated in FIG. 4. As tank 30 is duplicative of the tank shown in FIG. 3, the same nomenclature and reference numerals will be used for common elements and a detailed description thereof need not be repeated.

It is well known that irradiating air or an oxygen containing gas at a pressure greater than ambient will result in more conversion of oxygen molecules to ozone molecules than if the air or gas is at ambient pressure. To increase the production of ozone molecules within annular space 80 in response to radiation of ultraviolet light from UV lamp 60, a compressor 92 is used to compress the gas flowing into cap 42 through conduit 94. To control the pressure of the gas within cap 42 and annular space 80 within sleeve 44, a regulator 96 may be used in conjunction with the conduit. As described above, the gas flowing through annular space 80 is subjected to ultraviolet radiation from UV lamp 60 and such radiation will convert some of the oxygen molecules to ozone molecules. The gas with the ozone molecules, which may be referred to as ozonated gas, is discharged through outlet 76 into conduit 98. A pressure regulator 100 is disposed in conduit 98 to maintain the gas and ozone molecules flowing through annular space 80 at a pre-determined pressure. The ozonated gas discharged from regulator 100 flows through a further conduit 102 into a chamber 104.

The water to be purified, represented by arrow 106, flows through a conduit 108 into a silver media cartridge 110, which cartridge may be any one of several commercially available cartridges. The purpose of the silver media cartridge is to introduce silver into the inflowing water. The water discharged from the silver media cartridge flows into chamber 104 via a conduit 112. The flow of ozonated air or gas through conduit 102 into chamber 104 is discharged through a diffuser, such as a sparger 114, to entrain bubbles of ozonated air or gas in the water within the chamber. It is to be understood that various other devices may be used in place of the sparger to cause entrainment of bubbles of ozonated air or gas in the water within chamber 104. The water within chamber 104 now containing silver and entrained ozonated air or gas is discharged into tank 30, as represented by arrow 116 through a conduit 118. The water inflowing through inlet 34 will swirl about sleeve 44, as represented by arrows 32. During such swirling, the water will be irradiated by UV lamp 60 to convert some of the oxygen molecules present into ozone molecules. Moreover, the UV254 radiation will have a germicidal and virucidal effect upon microorganisms that may be present. Additionally, hydroxyl radicals will be formed, as discussed in further detail above. The UV irradiated water containing silver, ozone molecules and hydroxyl radicals is discharged through outlet 36 for use by an end user, as represented by arrow 39.

The silver media in the cartridge can be any type of media that releases silver. Examples of such silver media include: silver metal deposited on carbon, alumina, titania, zeolite, or other inorganic or organic substrate. The prior art describes processes for making such a media (see, for example, U.S. Pat. No. 6,383,273). The concentration of silver on the substrate can be several weight percent (e.g. 30%) or less than 1 weight percent (1%) provided that the silver is released into the water in the desired concentration range. The concentration of silver to be delivered to the water is preferably less than 400 ppb and more preferably less than 125 ppb. Some examples of silver compounds that can be used to prepare the media include, but are not limited to, silver nitrate, silver carbonate, silver acetate and silver chloride. Alternatively, a solution of silver salts can be injected into the water. An example would be a solution of silver nitrate that is connected to a volumetric pump, which delivers the silver nitrate solution at a rate commensurate with the water flow to achieve the desired silver concentration.

To confirm the efficacy of the present invention, a number of experiments were conducted. These experiments (examples) and the results obtained are set forth below.

### Examples 1-8

In examples 1-8, the biocidal efficacy against E. Coli of both silver and chlorine in the presence of three different concentrations of Total Organic Carbon (TOC) (i.e. 0 mg/L, 3 mg/L and 10 mg/L) were compared. In all cases, the starting water was de-chlorinated tap water. The TOC was generated by addition of humic acid. These tests measure the ability of these two secondary disinfectants to remain biocidal in water for extended periods of time should the water be ladened with natural organic matter. As can be seen from examples 1-4, silver is not affected by the presence of humates whereas chlorine (examples 5-8) readily loses its biocidal efficacy presumably due to oxidation of the humate by the chlorine. The controls had neither chlorine, silver nor TOC added.

Log₁₀ Reduction^{a} of E. coli (Initial Inoculum=4.50×10⁶ CFU/ml) after Exposure to Silver in the presence of Total Organic Carbon.

Log₁₀ Reduction^{a} of E. coli (initial inoculum = 4.50 × 10⁶ CFU/ml)
after exposure to silver in the presence of Total Organic Carbon.

| Exam- | | | | | | |
|---|---|---|---|---|---|---|
| ple | Test System | 1 hour | 2 hours | 3 hours | 4 hours | 7 hours |
| 1 | Control (0 | 0.01 | 0.03 | 0.05 | 0.07 | 0.09 |
| | μg/L Ag and | | | | | |
| | 0 mg/L TOC) | | | | | |
| 2 | 100 μg/L Ag | 2.51 | 4.40 | 5.55 | >5.65 | >5.65 |
| | and 0 mg/L | | | | | |
| | TOC | | | | | |
| 3 | 100 μg/L Ag | 2.51 | 4.40 | 5.55 | >5.65 | >5.65 |
| | and 3 mg/L | | | | | |
| | TOC | | | | | |
| 4 | 100 μg/L Ag | 2.39 | 4.40 | 5.55 | >5.65 | >5.65 |
| | and 10 mg/L | | | | | |
| | TOC | | | | | |

^{a}Average Log₁₀ reduction of triplicate tests

Log₁₀ Reduction^{a} of E. coli (Initial Inoculum=5.00×10⁶ CFU/ml) after Exposure to Chlorine in the Presence of Total Organic Carbon

Log₁₀ Reduction^{a} of E. coli (initial inoculum = 5.00 × 10⁶
CFU/ml) after exposure to chlorine in the presence
of Total Organic Carbon.

| Exam- | | | | | | |
|---|---|---|---|---|---|---|
| ple | Test System | 1 hour | 2 hours | 3 hours | 4 hours | 7 hours |
| 5 | Control (0 | 0.00 | 0.01 | 0.03 | 0.05 | 0.07 |
| | mg/L Cl and | | | | | |
| | 0 mg/L TOC) | | | | | |
| 6 | 0.2 mg/L Cl | >5.70 | >5.70 | >5.70 | >5.70 | >5.70 |
| | and 0 mg/L | | | | | |
| | TOC | | | | | |
| 7 | 0.2 mg/L Cl | 0.13 | 0.15 | 0.15 | 0.17 | 0.19 |
| | and 3 mg/L | | | | | |
| | TOC | | | | | |
| 8 | 0.2 mg/L Cl | 0.14 | 0.16 | 0.17 | 0.17 | 0.18 |
| | and 10 mg/L | | | | | |
| | TOC | | | | | |

^{a}Average Log₁₀ reduction of triplicate tests

### Examples 9-20

In examples 9-20, the biocidal efficacy of UV, ozone and silver were assessed by observing the Log₁₀ reduction of MS-2 bacteriophage. In all cases, the starting water was de-chlorinated tap water. A flow-through 2-liter per minute water treatment device providing a dosage of 50 mJ/cm² UV was used. The UV lamp was allowed to warm up for three minutes prior to each experiment. The ozone being generated by the UV lamp was injected into the water stream immediately in front of the UV chamber. The ozone dose was approximately 0.08 mg/l. In the experiments using silver (Ag), the silver (as silver nitrate) was added either five (5) minutes prior to simultaneous UV/Ozone exposure, or was added afterwards (with a five (5) minute incubation prior to addition of the neutralizer). The concentration of silver used was 100 ppb. From the data, it can be concluded that employing silver prior to the UV and ozone is advantageous.

Log₁₀ reduction of MS-2 after exposure to various
combinations of UV, ozone and silver

| | | Initial virus | Virus | |
|---|---|---|---|---|
| | | inoculum | (Pfu-ml) | Log₁₀ |
| Example | Test System | (pfu/ml) | Recovered | Reduction |
| 9 | UV only | 2.88 × 10⁶ | 3.17 × 10³ | 2.96 |
| 10 | UV only | 1.93 × 10⁷ | 8.6 × 10³ | 3.36 |
| 11 | Ozone only | 1.93 × 10⁷ | 1.88 × 10⁶ | 1.01 |
| 12 | Ozone only | 2.88 × 10⁶ | 3.88 × 10⁵ | 0.87 |
| 13 | UV/Ozone | 2.88 × 10⁶ | 2.80 × 10² | 4.01 |
| 14 | UV/Ozone | 1.16 × 10⁸ | 1.53 × 10⁴ | 3.88 |
| 15 | UV/Ozone | 1.93 × 10⁷ | 4.88 × 102 | 4.45 |
| 16 | UV/Ozone followed | 1.16 × 10⁸ | 2.95 × 10⁴ | 3.61 |
| | by silver | | | |
| 17 | Silver followed by | 1.93 × 10⁷ | 2 × 10¹ | 5.98 |
| | UV/Ozone | | | |
| 18 | Silver followed by | 1.16 × 10⁸ | 5.35 × 10² | 5.33 |
| | UV/Ozone | | | |
| 19 | Silver followed by | 2.88 × 1O⁶ | <5 | >5.76 |
| | UV/Ozone | | | |
| 20 | Silver only (5- | 1.16 × 10⁸ | 1.16 × 10⁸ | 0 |
| | minute exposure, | | | |
| | no UV or Ozone) | | | |

^{a}Average Log₁₀ reduction of triplicate measurements

### Examples 21-25

In examples 21-25, the biocidal efficacy of UV, ozone and silver were assessed by observing the Log₁₀ reduction of Adenovirus type 2. In all cases, the starting water was de-chlorinated tap water. A flow-through 2-liter per minute water treatment device providing a dosage of 50 mJ/cm² UV was used. The UV lamp was allowed to warm up for three minutes prior to each experiment. The ozone, being generated by the UV lamp, was injected into the water stream immediately in front of the UV chamber. The ozone dose was approximately 0.05 mg/L. In the experiment using sliver (Ag), the silver (as silver nitrate) was added three (3) minutes prior to simultaneous UV/Ozone exposure. The concentration of silver used was 100 ppb. From the data, it can be concluded that employing silver prior to the UV and ozone is advantageous.

Log₁₀ Reduction of Adenovirus 2 after exposure
to various combinations of UV, ozone and silver

| | | Initial virus | Virus | |
|---|---|---|---|---|
| | | inoculum | (TCID₅₀/ml) | Log₁₀ |
| Example | Test System | (TCID₅₀/ml) | Recovered | Reduction |
| 21 | UV only | 1.33 × 10⁶ | 4.50 × 10³ | 2.47 |
| 22 | Ozone only | 1.33 × 10⁶ | 2.08 × 10⁵ | 0.81 |
| 23 | UV/Ozone | 1.33 × 10⁶ | 5.02 × 10¹ | 4.42 |
| 24 | UV/Ozone/Ag | 1.33 × 10⁶ | <3.73 × 10⁰ | >5.55 |
| 25 | Ag only | 1.33 × 10⁶ | 1.33 × 10⁶ | 0 |

We claim:

1. Apparatus for inactivating microorganisms in water from a source and for controlling biological regrowth in downstream water systems, said apparatus comprising in combination:
a) a water tank;
b) a sleeve disposed with said tank for conveying a flow of oxygen containing gas therethrough;
c) a UV lamp disposed within said sleeve for converting oxygen molecules of the gas flowing through said sleeve into ozone molecules, for irradiating the water within said tank and for producing hydroxyl radicals;
d) silver for entrainment in the water;
e) a conduit for introducing the silver with the water from the source of water;
f) a further conduit connected with said sleeve to convey the gas and ozone molecules contained therein away from said sleeve;
g) a venturi for receiving the silver containing water and for creating a low pressure environment therein, said further conduit being connected to said venturi for conveying the gas and ozone molecules into said venturi for entrainment with the water flowing through said venturi in response to the low pressure environment;
h) a yet further conduit for conveying the water from said venturi into said tank to subject the water to radiation from said UV lamp and enable the production of hydroxyl radicals; and
i) an outlet for conveying the water containing ozone, silver and hydroxyl radicals from said tank to a point of use.

2. The apparatus for inactivating microorganisms in water as set forth in claim 1 wherein said UV lamp radiates ultraviolet light at a wavelength of 185 nm.

3. The apparatus for inactivating microorganisms in water as set forth in claim 1 wherein said UV lamp radiates ultraviolet light at a wavelength of 254 nm.

4. The apparatus for inactivating microorganisms in water as set forth in claim 3 wherein said UV also lamp radiates ultraviolet light at a wavelength of 185 nm.

5. The apparatus for inactivating microorganisms in water as set forth in claim 1 wherein the silver is a silver media selected from the group consisting of silver nitrate, silver carbonate, silver acetate and silver chloride.

6. The apparatus for inactivating microorganisms in water as set forth in claim 5 wherein the concentration of silver is less than 450 ppb.

7. The apparatus for inactivating microorganisms in water as set forth in claim 6 wherein the concentration of silver is less than 125 ppb.

8. The apparatus for inactivating microorganisms in water as set forth in claim 1 wherein the silver is silver metal deposited on a substrate selected from the group consisting of carbon, alumina, titania, zeolite, inorganic material and organic material.

9. The apparatus for inactivating microorganisms in water as set forth in claim 8 wherein the concentration of silver is less than 450 ppb.

10. The apparatus for inactivating microorganisms in water as set forth in claim 9 wherein the concentration of silver is less than 125 ppb.

11. Apparatus for treating water to inactivate microorganisms in water from a source and to control biological regrowth in downstream water systems, said apparatus comprising in combination:
a) a water tank;
b) a sleeve disposed within said tank for conveying a flow of oxygen containing gas therethrough;
c) a UV lamp disposed within said sleeve for converting oxygen molecules of the gas flowing through said sleeve into ozone molecules and for irradiating the water within said tank;
d) a source of the gas under pressure and a conduit for conveying the gas from said source into said sleeve;
e) a water chamber;
f) silver for entrainment in the water;
g) an inlet for conveying silver containing the water to be treated from the source of water;
h) a conduit for conveying the water to be treated from said cartridge into said water chamber;
i) a further conduit interconnecting said sleeve with a diffuser disposed in said water chamber for discharging through said diffuser the gas into the water to be treated;
j) a yet further conduit for conveying the water from said water chamber to said water tank to irradiate the water with radiation from said UV lamp and to produce hydroxyl radicals;
k) a pressure regulator for maintaining the pressure of the gas within said sleeve to enhance the production of ozone molecules within said sleeve and;
l) an outlet for conveying the treated water to a point of use.

12. The apparatus for treating water to kill microorganisms in water as set forth in claim 11 wherein said UV lamp radiates ultraviolet light at a wavelength of 185 nm.

13. The apparatus for treating water to kill microorganisms in water as set forth in claim 11 wherein said UV lamp radiates ultraviolet light at a wavelength of 254 nm.

14. The apparatus for treating water to kill microorganisms in water as set forth in claim 13 wherein said UV lamp also radiates ultraviolet light at a wavelength of 185 nm.

15. The apparatus for treating water to inactivate microorganisms in water as set forth in claim 11 wherein the silver is a silver media selected from the group consisting of silver nitrate, silver carbonate, silver acetate and silver chloride.

16. The apparatus for treating water to inactivate microorganisms in water as set forth in claim 15 wherein the concentration of silver is less than 450 ppb.

17. The apparatus for treating water to inactivate microorganisms in water as set forth in claim 16 wherein the concentration of silver is less than 125 ppb.

18. The apparatus for treating water to inactivate microorganisms in water as set forth in claim 11 wherein the silver is silver metal deposited on a substrate selected from the group consisting of carbon, alumina, titania, zeolite, inorganic material and organic material.

19. The apparatus for treating water to inactivate microorganisms in water as set forth in claim 18 wherein the concentration of silver is less than 450 ppb.

20. The apparatus for treating water to inactivate microorganisms in water as set forth in claim 19 wherein the concentration of silver is less than 125 ppb.

21. A method for treating water to inactivate microorganisms and to prevent growth of bio-film in a water system, said method comprising in combination:
a) irradiating a gas containing oxygen molecules with ultraviolet light to convert oxygen molecules into ozone molecules and produce an ozonated gas;
b) conveying silver into the water to be treated;
c) entraining the ozonated gas in the water containing silver to produce ozonated water containing silver and to oxidize organic matter in the water;
d) further irradiating the water subsequent to said entraining step with ultraviolet light from a UV lamp to inactivate microorganisms, to further convert oxygen molecules in the water to ozone molecules and produce hydroxyl radicals in the water; and
e) discharge the treated water to a point of use.

22. The method as set forth in claim 21 wherein said step of irradiating is carried out by a UV lamp radiating ultraviolet light at a wavelength of 185 nm.

23. The method as set forth in claim 21 wherein said step of irradiating is carried out by a UV lamp radiating ultraviolet light at a wavelength of 254 nm.

24. The method as set forth in claim 21 wherein said step of irradiating is carried out by a UV lamp radiating ultraviolet light at wavelengths of at least 185 nm and 254 nm.

25. The method as set forth in claim 21 wherein said step of conveying is carried out through a cartridge containing silver media selected from the group consisting of silver nitrate, silver carbonate, silver acetate and silver chloride.

26. The method as set forth in claim 21 wherein said step of conveying is carried out through a cartridge containing silver metal deposited on a substrate selected from the group consisting of carbon, alumina, titania, zeolite, inorganic material and organic material.

27. The method as set forth in claim 21, including the step of pressurizing the gas during exercise of said step of irradiating.

28. The method as set forth in claim 27, including the step of regulating the pressure of the gas during exercise of said step of pressurizing.

29. The method as set forth in claim 28 wherein said step of entraining is carried out with a diffuser disposed in the water to be ozone enriched.

30. The method as set forth in claim 21 wherein said step of entraining is carried out with a diffuser.

31. The method as set forth in claim 21 wherein said step of entraining is carried out with a venturi.

32. The method as set forth in claim 21 wherein said step of irradiating is carried out within an annular space defined by a UV lamp and a surrounding sleeve.

33. The method as set forth in claim 32 wherein said step of further irradiating is carried out through a UV transmissive sleeve.

34. Apparatus for treating water and for preventing growth of bio-film in a water distribution system, said apparatus comprising in combination:
a) a source of silver for introducing silver into the water;
b) a source of ultraviolet light for irradiating an oxygen containing gas to convert oxygen molecules in oxygen containing gas to ozone molecules and produce an ozonated gas;
c) means for entraining the ozonated gas in the water containing silver to oxidize organic matter in the water;
d) means for irradiating with ultraviolet light the water containing silver and ozone molecules to inactivate microorganisms that may be present, to convert further oxygen molecules to ozone molecules and to produce hydroxyl radicals; and
e) a conduit for conveying the treated water into the water distribution system.

35. The apparatus for treating water and for preventing growth of bio-film in a water distribution system as set forth in claim 34 wherein said irradiating means comprises said ultraviolet radiation radiating ultraviolet light at wavelengths of at least 185 nm and 254 nm.

36. The apparatus for treating water and for preventing growth of bio-film in a water distribution system as set forth in claim 34, including a compressor for compressing the oxygen containing gas prior to irradiating the oxygen containing gas with ultraviolet light.

37. The apparatus for treating water and for preventing growth of bio-film in a water distribution system as set forth in claim 36, including a pressure regulator for maintaining the oxygen containing gas under pressure during irradiation of the oxygen containing gas.

38. The apparatus for treating water and for preventing growth of bio-film in a water distribution system as set forth in claim 34 wherein said entraining means comprises a diffuser.

39. The apparatus for treating water and for preventing growth of bio-film in a water distribution system as set forth in claim 38 wherein said diffuser comprises a sparger.

40. The apparatus for treating water and for preventing growth of bio-film in a water distribution system as set forth in claim 34 wherein said entraining means comprises a venturi.
